(19) United States
(12) Patent Application Publication
(10) Pub. No.: US 2026/0118899 A1
(43) Pub. Date: Apr. 30, 2026

(54) POWER CONSUMPTION AMOUNT ADJUSTMENT DEVICE, NUMERICAL CONTROL DEVICE, AND POWER CONSUMPTION AMOUNT ADJUSTMENT METHOD

(71) Applicant: Mitsubishi Electric Corporation, Tokyo (JP)

(72) Inventors: Takanobu KAWAGUCHI, Tokyo (JP); Tomoya FUJITA, Tokyo (JP); Kosuke TSUJIKAWA, Tokyo (JP)

(73) Assignee: Mitsubishi Electric Corporation, Tokyo (JP)

(21) Appl. No.: 19/143,390

(22) PCT Filed: May 10, 2023
(86) PCT No.: PCT/JP2023/017550

§ 371 Date: Jun. 26, 2025

(51) Int. Cl. G05F 1/66; G05F 1/12; G05F 1/46

(52) U.S. Cl. CPC G05F 1/66; G05F 1/12; G05F 1/463

(57) ABSTRACT

A power consumption amount adjustment device that adjusts the amount of power consumption of a numerical control machine tool driving a motor and performing machining according to a machining program includes: a machining condition information generation unit generating, based on a previous power consumption amount at a time of previous execution of a machining program, a current power consumption amount at a time of current execution of the machining program, and a current machining condition at a time of current execution of the machining program affecting the current power consumption amount, machining condition change amount for determining a next machining condition at a time of next execution of the machining program affecting the next power consumption amount so that a next power consumption amount at a time of next execution of the machining program becomes smaller than the current power consumption amount.

### FIELD

The present disclosure relates to a power consumption amount adjustment device that approximates, to an optimum value, the amount of power consumption of a machine tool that performs machining in accordance with a machining program, while reducing the amount of power consumption, a numerical control device, and a power consumption amount adjustment method.

### BACKGROUND

In an industrial machine tool that repeats machining of the same component, such as a machine tool that drives a motor and performs machining in accordance with a machining program, it is required to reduce the amount of power consumption per component during machining.

A control device described in Patent Literature 1 determines a target time constant having a relative relationship with at least one of an acceleration time and a deceleration time of a feed shaft driving motor on the basis of the sum of the amount of power consumption of the feed shaft driving motor and the amount of power consumption of an instrument operating at a constant power, and controls the feed shaft driving motor on the basis of the target time constant, thereby reducing the amount of power consumption of a machine tool as a whole.

### CITATION LIST

### Patent Literature

Patent Literature 1: Japanese Patent Application Laid-open No. 2010-250697

### SUMMARY OF INVENTION

### Problem to be Solved by the Invention

However, with the technique of Patent Literature 1, even if the target time constant is once determined, various machining conditions including the target time constant for minimizing the amount of power consumption are changed by friction and heat generated as machining progresses, and the change cannot be followed.

The present disclosure has been made in view of the above, and an object thereof is to provide a power consumption amount adjustment device capable of easily realizing reduction in the amount of power consumption with a simple process even in a case where various machining conditions for minimizing the amount of power consumption are changed by friction and heat generated by machining.

### Means to Solve the Problem

In order to solve the above-described problems and achieve the object, the present disclosure is a power consumption amount adjustment device that adjusts an amount of power consumption of a numerical control machine tool that drives a motor and performs machining in accordance with a machining program, the power consumption amount adjustment device including: a machining condition information generation unit to generate, on a basis of a previous power consumption amount that is an amount of power consumption at a time of previous execution of a machining program, a current power consumption amount that is an amount of power consumption at a time of current execution of the machining program, and a current machining condition that is a machining condition at a time of current execution of the machining program and affects the current power consumption amount, machining condition information for determining a next machining condition so that a next power consumption amount that is an amount of power consumption at a time of next execution of the machining program becomes smaller than the current power consumption amount, the next machining condition being a machining condition at a time of next execution of the machining program and affecting the next power consumption amount.

### Effects of the Invention

The power consumption amount adjustment device according to the present disclosure achieves an effect that it is possible to easily realize reduction in the amount of power consumption with a simple process even in a case where various machining conditions for minimizing the amount of power consumption are changed by friction and heat generated by machining.

### BRIEF DESCRIPTION OF DRAWINGS

FIG. 1 is a view illustrating a configuration of a machine tool device of a numerical control machine tool to which a power consumption amount adjustment device according to a first embodiment is applied.

FIG. 2 is a block diagram illustrating a configuration of a numerical control machining system including the power consumption amount adjustment device according to the first embodiment.

FIG. 3 is a block diagram illustrating a configuration of the power consumption amount adjustment device according to the first embodiment.

FIG. 4 is a flowchart illustrating a processing procedure of a process in which the numerical control machining system according to the first embodiment adjusts the amount of override.

FIG. 5 is a diagram for explaining the process in which the numerical control machining system according to the first embodiment adjusts the amount of override.

FIG. 6 is a block diagram illustrating a configuration of a numerical control machine tool according to a second embodiment.

FIG. 7 is a block diagram illustrating a configuration of a numerical control device according to the second embodiment.

FIG. 8 is a block diagram illustrating a configuration of a numerical control machining system including a power consumption amount adjustment device according to a third embodiment.

FIG. 9 is a block diagram illustrating a configuration of the power consumption amount adjustment device according to the third embodiment.

FIG. 10 is a block diagram illustrating a configuration of a power consumption amount adjustment device according to a fourth embodiment.

FIG. 11 is a block diagram illustrating a configuration of a machine learning device included in the power consumption amount adjustment device according to the fourth embodiment.

FIG. 12 is a diagram illustrating an exemplary hardware configuration that realizes the power consumption amount adjustment device according to the fourth embodiment.

### DESCRIPTION OF EMBODIMENTS

Hereinafter, a power consumption amount adjustment device, a numerical control device, and a power consumption amount adjustment method according to each embodiment of the present disclosure will be described in detail with reference to the drawings.

### First Embodiment

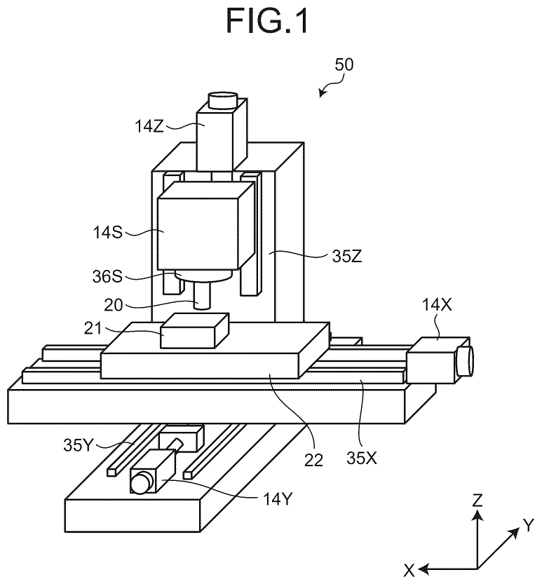

FIG. 1 is a view illustrating a configuration of a machine tool device of a numerical control machine tool to which a power consumption amount adjustment device according to a first embodiment is applied. In the following description, two axes in a plane parallel to an upper surface of a table 22, the two axes being orthogonal to each other, are defined as an X axis and a Y axis. An axis orthogonal to the X axis and the Y axis is defined as a Z axis.

A power consumption amount adjustment device (a power consumption amount adjustment device 30A to be described later) according to the first embodiment is applied to a numerical control machine tool (a numerical control machine tool 100A to be described later) including a machine tool device 50. FIG. 1 schematically illustrates an outline of the machine tool device 50.

The machine tool device 50 is a mechanical device included in the numerical control machine tool 100A, and repeatedly executes cutting of the same object to be machined (component). The machine tool device 50 is, for example, a three-axis machining center.

The machine tool device 50 includes an X-axis motor 14X, a Y-axis motor 14Y, a Z-axis motor 14Z, a spindle motor 14S, an X-axis portion 35X, a Y-axis portion 35Y, and a Z-axis portion 35Z, as well as a spindle portion 36S. The X-axis motor 14X, the Y-axis motor 14Y, and the Z-axis motor 14Z are servo motors.

The machine tool device 50 cuts a workpiece 21 by using a tool 20 to realize a desired shape. At that time, the machine tool device 50 drives the workpiece 21 installed on the table 22 in the X-axis direction and the Y-axis direction by using the X-axis portion 35X extending in the X-axis direction and moving in the X-axis direction and the Y-axis portion 35Y extending in the Y-axis direction and moving in the Y-axis direction. In addition, the machine tool device 50 drives the tool 20 in the Z-axis direction by using the Z-axis portion 35Z extending in the Z-axis direction and moving in the Z-axis direction. Consequently, the machine tool device 50 creates a three-dimensional motion.

The machine tool device 50 rotates the tool 20 by the spindle portion 36S in which the 2-axis direction is an axial direction, thereby generating a relative motion of the tool 20 with respect to the workpiece 21 to remove a material from the surface of the workpiece 21. At that time, the machine tool device 50 drives shafts of the X-axis portion 35X, the Y-axis portion 35Y, and the Z-axis portion 35Z by the X-axis motor 14X, the Y-axis motor 14Y, and the Z-axis motor 14Z, and drives the spindle portion 36S by the spindle motor 14S.

In the following description, in a case where it is not necessary to distinguish the X-axis motor 14X, the Y-axis motor 14Y, the Z-axis motor 14Z, and the spindle motor 14S, each of the X-axis motor 14X, the Y-axis motor 14Y, the Z-axis motor 14Z, and the spindle motor 14S may be referred to as a motor.

The X-axis portion 35X, the Y-axis portion 35Y, and the Z-axis portion 35Z each include a feed shaft. The feed shaft is a device that converts rotational motion of the X-axis motor 14X, the Y-axis motor 14Y, and the Z-axis motor 14Z into linear motion of the shaft by a mechanical device called a ball screw.

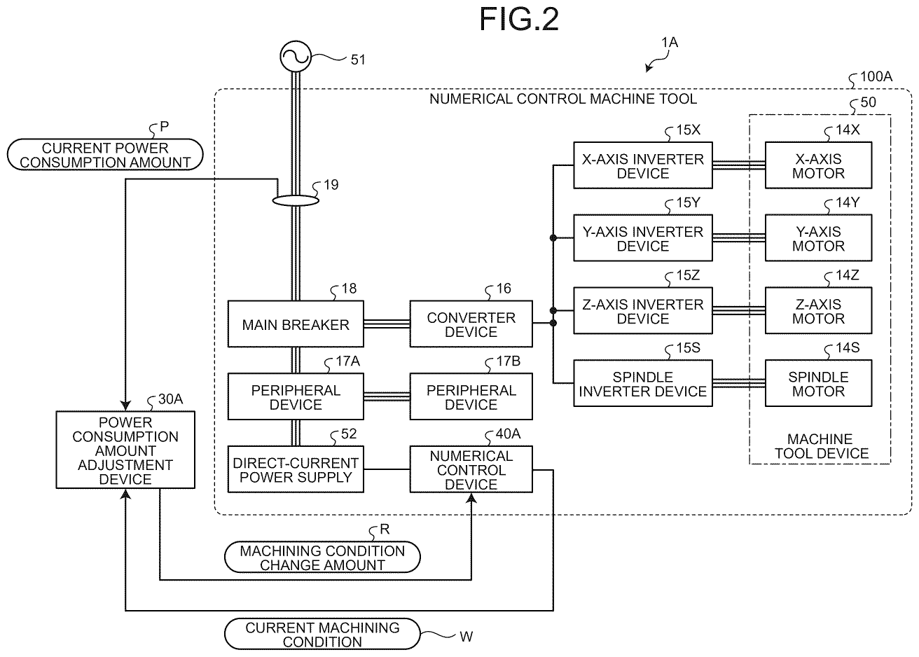

FIG. 2 is a block diagram illustrating a configuration of a numerical control machining system including the power consumption amount adjustment device according to the first embodiment. A numerical control machining system 1A includes the power consumption amount adjustment device 30A and the numerical control machine tool 100A.

In the numerical control machining system 1A, the numerical control machine tool 100A is connected to the power consumption amount adjustment device 30A. The numerical control machine tool 100A is connected to a main power supply (main power supply unit) 51 which is an alternating-current power supply.

The numerical control machine tool 100A includes a power consumption detection unit 19, a main breaker 18, peripheral devices 17A and 17B, a converter device 16, a direct-current power supply 52, and a numerical control device 40A. The numerical control machine tool 100A also includes an X-axis inverter device 15X, a Y-axis inverter device 15Y, a Z-axis inverter device 15Z, a spindle inverter device 15S, and the machine tool device 50.

In the following description, in a case where it is not necessary to distinguish the X-axis inverter device 15X, the Y-axis inverter device 15Y, the Z-axis inverter device 15Z, and the spindle inverter device 15S, each of the X-axis inverter device 15X, the Y-axis inverter device 15Y, the Z-axis inverter device 152, and the spindle inverter device 15S may be referred to as an inverter device.

In FIG. 2, among the components included in the machine tool device 50, only the X-axis motor 14X, the Y-axis motor 14Y, the Z-axis motor 142, and the spindle motor 14S are illustrated, and components other than the X-axis motor 14X, the Y-axis motor 14Y, the Z-axis motor 14Z, and the spindle motor 14S are not illustrated.

The power consumption detection unit 19 is disposed on a connection line connecting the main power supply 51 and the main breaker 18, and detects the amount of power consumption of the numerical control machine tool 100A. That is, the power consumption detection unit 19 detects the amount of power consumption of the main power supply 51 that inputs power to the numerical control machine tool 100A. The power consumption detection unit 19 sends the detected amount of power consumption (such as current power consumption amount P) to the power consumption amount adjustment device 30A.

The main breaker 18 is connected to the peripheral device 17A and the converter device 16. The peripheral device 17A is connected to the peripheral device 17B and the direct-current power supply 52, and the direct-current power supply 52 is connected to the numerical control device 40A. The numerical control device 40A is connected to the power consumption amount adjustment device 30A.

The converter device 16 is connected to the X-axis inverter device 15X, the Y-axis inverter device 15Y, the Z-axis inverter device 15Z, and the spindle inverter device 15S. The inverter devices are connected to the corresponding motors and drive the motors. That is, the X-axis inverter device 15X is connected to the X-axis motor 14X and drives the X-axis motor 14X. The Y-axis inverter device 15Y is connected to the Y-axis motor 14Y and drives the Y-axis motor 14Y. The Z-axis inverter device 15Z is connected to the Z-axis motor 14Z and drives the Z-axis motor 14Z. The spindle inverter device 15S is connected to the spindle motor 14S and drives the spindle motor 14S.

The alternating-current power from the main power supply 51 is input from the main breaker 18 and sent to the converter device 16, the peripheral device 17A, the peripheral device 17B, and the direct-current power supply 52.

The direct-current power supply 52 generates, from the alternating-current power, direct-current power necessary for driving the numerical control device 40A. The converter device 16 generates, from the alternating-current power, direct-current power to be supplied to the inverter devices.

In the numerical control machine tool 100A, machining is performed by the numerical control device 40A repeatedly executing a machining program. The machining program is described in a language such as an Electronic Industries Alliance (EIA) code, and for example, a command position of each feed shaft and a command speed at that time, the rotation speed of the spindle, and the like are described in order.

The numerical control device 40A analyzes the machining program and generates position command values for the motors connected to the machine tool device 50. The numerical control device 40A transmits the generated position command values to the inverter devices. In FIG. 2, a connection line between the numerical control device 40A and each of the inverter devices is not illustrated.

Each inverter device generates, from the direct-current power generated by the converter device 16, an alternating current to be flowed to the corresponding motor. The inverter device controls the alternating current to be flowed to the motor so that the motor follows the position command. As a method for controlling the alternating current by the inverter device, for example, there is pulse width modulation (PWM) control, but any control method may be used as the method for controlling the alternating current. The motor generates a torque depending on the alternating current supplied by the inverter device, and thereby the machine tool device 50 connected to the motor is driven.

The peripheral devices 17A and 17B drive an instrument to be driven (not illustrated in FIG. 2) by using alternating-current power from the main power supply 51. Examples of the instrument to be driven which is driven by the peripheral devices 17A and 17B include a chiller that circulates a coolant to the machine tool device 50, and a pump that circulates a coolant. The instrument to be driven which is driven by the peripheral devices 17A and 17B is an example, and includes all instruments that consume power other than a motor that generates motion of a shaft necessary for machining, such as a fan for cooling a power distribution board and sensors attached to the machine tool device 50.

The numerical control device 40A of the first embodiment controls machining under a machining condition that affects the amount of power consumption. As elements of the machining condition used by the numerical control device 40A, for example, there are five elements, i.e., the amount of override of a specific element during machining, an acceleration time constant, a feed speed, a spindle rotation speed, and a pulse width modulation (PWM) carrier frequency. The numerical control device 40A of the first embodiment controls machining under a machining condition used for current machining (hereinafter, referred to as a current machining condition W), and outputs the current machining condition W to the power consumption amount adjustment device 30A. The current machining condition W is a machining condition of the current machining that affects the current power consumption amount P which is the amount of power consumption in the current machining. A next machining condition to be described later is a machining condition of the next machining that affects a next power consumption amount which is the amount of power consumption in the next machining.

When the machining is completed, the numerical control device 40A receives a machining condition change amount R from the power consumption amount adjustment device 30A. The machining condition change amount R is the amount of change from the current machining condition W to a machining condition to be used for the next machining (next machining condition). In the first embodiment, information on the machining condition to be used for the next machining (machining condition information) is the machining condition change amount R.

The numerical control device 40A changes the current machining condition W on the basis of the machining condition change amount R. The numerical control device 40A sets the current machining condition W that has been changed on the basis of the machining condition change amount R as the next machining condition to be used for the next machining.

The power consumption amount adjustment device 30A calculates the machining condition change amount R on the basis of the current power consumption amount P which is the amount of power consumption detected when the numerical control machine tool 100A performs machining under the current machining condition W, and outputs the machining condition change amount R to the numerical control device 40A.

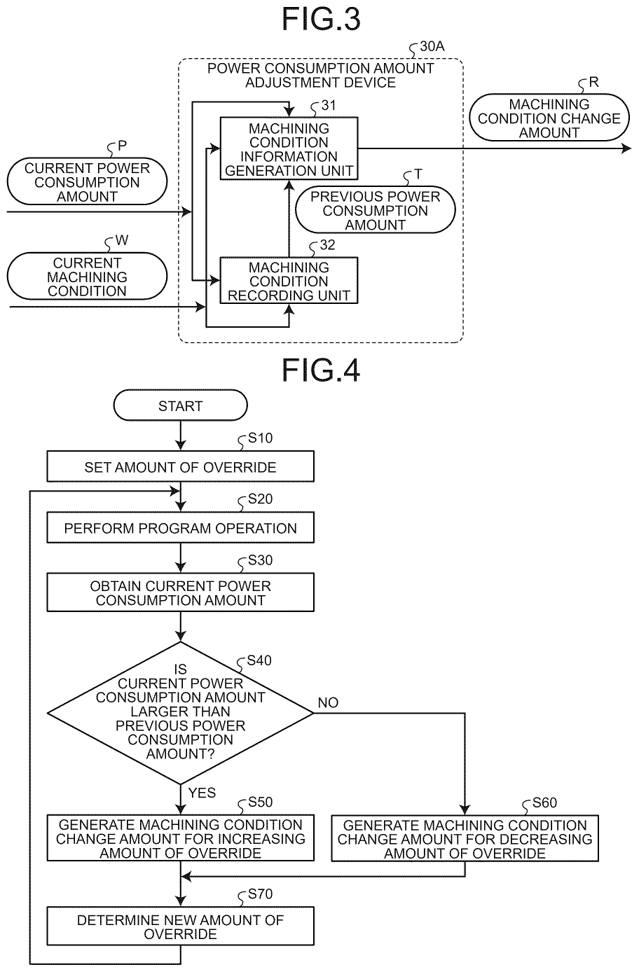

FIG. 3 is a block diagram illustrating a configuration of the power consumption amount adjustment device according to the first embodiment. Each time one object to be machined (workpiece 21) is machined, the power consumption amount adjustment device 30A acquires the current power consumption amount P taken for the current machining and the current machining condition W from the numerical control machine tool 100A. The power consumption amount adjustment device 30A acquires, from the power consumption detection unit 19, the amount of power supplied to the main breaker 18 as the current power consumption amount P.

The power consumption detection unit 19 calculates the current power consumption amount P by measuring, for example, a voltage applied to the main breaker 18 and a current flowing through the main breaker 18 with a clamp meter. However, the clamp meter is an example, and the power consumption detection unit 19 may use any measurement means as long as the amount of power consumption can be measured.

The power consumption amount adjustment device 30A includes a machining condition information generation unit 31 and a machining condition recording unit 32. The machining condition information generation unit 31 receives the current power consumption amount P from the power consumption detection unit 19 and receives the current machining condition W from the numerical control device 40A. The machining condition recording unit 32 receives the current power consumption amount P from the power consumption detection unit 19 and receives the current machining condition W from the numerical control device 40A.

The current power consumption amount P is recorded as the amount of power consumption in the current machining until the machining condition change amount R for setting the next machining condition which is the machining condition of the next machining is determined, but is recorded as the amount of power consumption in the previous machining (hereinafter referred to as a previous power consumption amount T) after the machining condition change amount R is determined.

The current machining condition W is recorded as the machining condition of the current machining until the machining condition change amount R for setting the next machining condition is determined, but is recorded as the previous machining condition after the machining condition change amount R is determined.

The previous power consumption amount T at the time of previous execution of the machining program is recorded in the machining condition recording unit 32 in association with the previous machining condition at the time of the previous execution of the machining program. The current power consumption amount P at the time of current execution of the machining program is associated with the current machining condition W at the time of the current execution of the machining program and recorded in the machining condition recording unit 32. The machining condition recording unit 32 records the amount of power consumption and the machining condition of each machining associated with each other. The amount of power consumption and the machining condition of each machining recorded in the machining condition recording unit 32 can be used for machine learning of correspondence between the amounts of power consumption and the machining conditions.

The machining condition information generation unit 31 generates, as the machining condition information, the machining condition change amount R corresponding to the next machining condition to be used in the next machining on the basis of the previous power consumption amount T recorded in the machining condition recording unit 32, the current power consumption amount P currently acquired, and the current machining condition W currently acquired. The machining condition change amount R is a difference between the current machining condition W and the next machining condition. The machining condition information generation unit 31 calculates the machining condition change amount R for the current machining condition W and sends the machining condition change amount R to the numerical control device 40A.

The current machining condition W and the next machining condition include at least one of the amount of override of a specific element during machining, an acceleration time constant, a feed speed, a spindle rotation speed, and a pulse width modulation (PWM) carrier frequency, for example. That is, the machining condition change amount R includes the amount of change of at least one of the acceleration time constant, the feed speed, the spindle rotation speed, the pulse width modulation (PWM) carrier frequency, and the like. Here, an example will be described in which the current machining condition W and the next machining condition are each the amount of override during machining, and the amount of override is adjusted.

The amount of override is a parameter commanded by the numerical control device 40A. The numerical control device 40A changes a command speed for a feed shaft described in the machining program at a rate described in the amount of override. For example, in a case where the amount of override is set to 120% when a command feed speed to the feed shaft described in the machining program is 1000 mm/min, the numerical control device 40A changes the command so that the feed shaft is driven at a speed of 1200 mm/min.

When the amount of override increases, the command speed increases and the time required for machining is shortened, so that the amount of power consumption of a device operating at a constant power consumption decreases. On the other hand, when the amount of override increases, a motor needs to be accelerated and decelerated quickly in a short time, and thus the current flowing through the motor increases, and the amount of power consumption of the motor increases. Therefore, whether the amount of power consumption of the numerical control machine tool 100A as a whole increases or decreases depends on the amount of override to be set. In addition, an optimum value of the amount of override also varies depending on the types and characteristics of the peripheral devices 17A and 17B attached to the numerical control machine tool 100A. In the first embodiment, the optimum value of the amount of override is a value at which the amount of power consumption becomes the optimum value (minimum value).

The power consumption amount adjustment device 30A of the first embodiment executes a power consumption amount adjustment process. The power consumption amount adjustment process in the first embodiment is a process of approximating the amount of power consumption to the optimum value while reducing the amount of power consumption. The power consumption amount adjustment device 30A calculates the machining condition change amount R so that the amount of power consumption at the time of the next execution of the machining program becomes smaller than the current power consumption amount P. Specifically, in a case where the current power consumption amount P is larger than the previous power consumption amount T, the machining condition information generation unit 31 calculates the machining condition change amount R for increasing the amount of override of the specific element. In a case where the current power consumption amount P is equal to or less than the previous power consumption amount T, the machining condition information generation unit 31 calculates the machining condition change amount R for decreasing the amount of override of the specific element.

As described above, the power consumption amount adjustment device 30A updates the machining condition (machining condition change amount R) on a per command (per machining) basis. Therefore, in a case where machining is performed a plurality of times, a machining condition for minimizing the amount of power consumption changes due to friction and heat generated as the machining progresses. Even in such a case, since the power consumption amount adjustment device 30A updates the machining condition on a per machining basis, it is possible to follow the change in the machining condition for minimizing the amount of power consumption. Note that the power consumption amount adjustment device 30A may perform not only update of the machining condition on a per command basis, but also update of the machining condition on a plurality of commands (a plurality of times of machining) basis. For example, the power consumption amount adjustment device 30A may update the machining condition every n (n is a natural number of 2 or more) times of machining.

Note that in a case where the current power consumption amount P and the previous power consumption amount T are the same, the machining condition information generation unit 31 may calculate the machining condition change amount R that does not change the amount of override. The power consumption amount adjustment device 30A sends the calculated machining condition change amount R to the numerical control device 40A.

FIG. 4 is a flowchart illustrating a processing procedure of a process in which the numerical control machining system according to the first embodiment adjusts the amount of override. The numerical control device 40A of the numerical control machine tool 100A sets the amount of override on the basis of the machining program (step S10).

The numerical control device 40A performs program operation using the machining program and the amount of override (step S20). An initial value of the amount of override set for the numerical control device 40A is, for example, 100%.

The numerical control device 40A generates a command value to the feed shaft or the like by using the amount of override, and executes machining control. The numerical control device 40A sends the current machining condition W to be used for the machining control to the power consumption amount adjustment device 30A. The current machining condition W is sent to the machining condition information generation unit 31 and the machining condition recording unit 32. The machining condition recording unit 32 records the current machining condition W sent from the numerical control device 40A.

The power consumption detection unit 19 of the numerical control machine tool 100A obtains the current power consumption amount P at the time of machining performed under the current machining condition W (step S30). That is, the power consumption detection unit 19 calculates the current power consumption amount P corresponding to the amount of override. The power consumption detection unit 19 sends the calculated current power consumption amount P to the power consumption amount adjustment device 30A. The current power consumption amount P is sent to the machining condition information generation unit 31 and the machining condition recording unit 32. Note that any one of the current machining condition W and the current power consumption amount P may be sent to the numerical control device 40A first.

The machining condition recording unit 32 records the current power consumption amount P sent from the power consumption detection unit 19. The current power consumption amount P recorded by the machining condition recording unit 32 is read, at the next machining, by the machining condition information generation unit 31 as the previous power consumption amount T which is the amount of power consumption in the previous machining.

In the numerical control machine tool 100A, a voltage value and a current value are detected by a drive unit, a converter unit, and the like. Therefore, the machining condition information generation unit 31 can calculate the amount of power consumption for each state of the motor alone, the drive unit alone, the converter unit alone, the peripheral devices 17A and 17B, and the numerical control machine tool 100A as a whole on the basis of the current power consumption amount P sent from the power consumption detection unit 19. Note that in the numerical control machine tool 100A, any measurement means may be used as long as the amount of power consumption of each component can be measured.

The machining condition information generation unit 31 compares the current power consumption amount P sent from the power consumption detection unit 19 with the previous power consumption amount T read from the machining condition recording unit 32. That is, the machining condition information generation unit 31 compares the previous power consumption amount T during the previous machining program operation with the current power consumption amount P during the current machining program operation.

The machining condition information generation unit 31 determines whether the current power consumption amount P is larger than the previous power consumption amount T. If the current power consumption amount P is larger than the previous power consumption amount T (step S40, Yes), the machining condition information generation unit 31 generates the machining condition change amount R for increasing the amount of override (step S50). Then, the machining condition information generation unit 31 sends the machining condition change amount R thus generated to the numerical control device 40A.

On the other hand, if the current power consumption amount P is equal to or less than the previous power consumption amount T (step S40, No), the machining condition information generation unit 31 generates the machining condition change amount R for decreasing the amount of override (step S60). Then, the machining condition information generation unit 31 sends the machining condition change amount R thus generated to the numerical control device 40A.

In a case where the current power consumption amount P and the previous power consumption amount T are the same, the machining condition information generation unit 31 determines the machining condition change amount R that does not change the amount of override. In that case, the machining condition information generation unit 31 may not send the machining condition change amount R thus determined to the numerical control device 40A.

The numerical control device 40A changes the current amount of override by the machining condition change amount R received from the machining condition information generation unit 31, and determines a new amount of override (step 370). The numerical control device 40A executes the next machining by using the new amount of override.

In first machining, the previous power consumption amount T to be compared is not recorded in the machining condition recording unit 32. Therefore, the machining condition information generation unit 31 determines the amount of change (for example, −58) preset for each type of machining condition as the machining condition change amount R and generates the machining condition change amount R. Consequently, the numerical control device 40A changes the amount of override (100%) as the initial value by the amount of change (for example, −5%) which is a parameter fixed value preset for each type of machining condition to obtain a new amount of override (95%).

Note that the machining condition information generation unit 31 may determine the machining condition change amount R to be “0” at the first machining. In that case, machining is executed with the amount of override (100%) as the initial value.

In the first machining, the machining condition information generation unit 31 records, in the machining condition recording unit 32, the amount of override as the initial value or the amount of override as the initial value changed by a preset parameter fixed value as the current machining condition W. In addition, the machining condition information generation unit 31 records, in the machining condition recording unit 32, the current power consumption amount P in a case where machining is performed with the amount of override applied to the first machining, in association with the current machining condition W. That is, in the first machining, the machining condition information generation unit 31 records, in the machining condition recording unit 32, the amount of override set in step S10 and the current power consumption amount P obtained in step S30.

In second and subsequent machining, the numerical control device 40A sets the new amount of override set in step S70 in the previous machining as the amount of override of current machining. Then, the machining condition information generation unit 31 records, in the machining condition recording unit 32, the amount of override currently set (the new amount of override determined in step S70 in the previous machining) and the current power consumption amount P obtained in step S30.

As described above, the machining condition information generation unit 31 records, in the machining condition recording unit 32, the determined new amount of override and the amount of power consumption in a case where machining is executed with the above amount of override, in association with each other.

When setting the new amount of override in step S70, the numerical control machining system 1A returns to the process of step S20, and repeats the processes of steps S20 to S70. That is, the numerical control machining system 1A repeatedly changes the amount of override on the basis of the amount of power consumption measured during the machining program operation, and determines the amount of override at which the amount of power consumption is minimized. As described above, the numerical control machining system 1A repeatedly changes the amount of override on the basis of the amount of power consumption measured during the machining program operation, and thus it is possible to approximate the machining condition such as the amount of override to an optimum value while reducing the amount of power consumption. That is, the numerical control machining system 1A can follow a minimum point of the amount of power consumption by repeatedly changing the amount of override.

Note that in the first machining, the machining condition information generation unit 31 determines the machining condition change amount R by changing the amount of override as the initial value by the parameter fixed value preset for each type of machining condition, but in the second and subsequent machining, the machining condition information generation unit 31 may determine the machining condition change amount R by any method.

Similarly to the first machining, in the second and subsequent machining, the machining condition information generation unit 31 may determine the machining condition change amount R by changing the amount of override as the initial value by the parameter fixed value preset for each type of machining condition. That is, the machining condition information generation unit 31 may change the machining condition change amount R by a constant value preset for each type of machining condition.

The machining condition information generation unit 31 may determine, as the machining condition change amount R, a value obtained by multiplying the current machining condition W by a specific ratio (coefficient) preset for each type of machining condition with respect to the amount of override of previous machining.

The machining condition information generation unit 31 may determine the machining condition change amount R on the basis of a ratio of the previous power consumption amount T and the amount of variation between the amount of power consumption in the previous machining and that in the current machining (hereinafter, sometimes referred to as the amount of power variation). In that case, the machining condition information generation unit 31 determines the machining condition change amount R by, for example, multiplying the current machining condition w by the ratio of the previous power consumption amount T and the amount of power variation.

The machining condition information generation unit 31 may determine the machining condition change amount R on the basis of a ratio of the current power consumption amount P and the amount of power variation. In that case, the machining condition information generation unit 31 determines the machining condition change amount R by, for example, multiplying the current machining condition W by the ratio of the current power consumption amount P and the amount of power variation.

The machining condition information generation unit 31 may determine the machining condition change amount R on the basis of a ratio of the previous power consumption amount T and the current power consumption amount P. In that case, the machining condition information generation unit 31 determines the machining condition change amount R by, for example, multiplying the current machining condition W by the ratio of the previous power consumption amount T and the current power consumption amount P.

The machining condition information generation unit 31 may determine the machining condition change amount R depending on an increase rate from the sum of energy losses of a motor calculated from the previous power consumption amount T to the sum of energy losses of the motor calculated from the current power consumption amount P.

For example, the machining condition information generation unit 31 determines the machining condition change amount R by multiplying the current machining condition W by the increase rate (rate of the amount of increase or decrease) from the sum of the energy losses of the motor calculated from the previous power consumption amount T to the sum of the energy losses of the motor calculated from the current power consumption amount P.

The machining condition information generation unit 31 may determine the machining condition change amount R depending on an increase rate from the sum of energy losses of a drive unit calculated from the previous power consumption amount T to the sum of energy losses of the drive unit calculated from the current power consumption amount P.

For example, the machining condition information generation unit 31 determines the machining condition change amount R by multiplying the current machining condition W by the increase rate from the sum of the energy losses of the drive unit calculated from the previous power consumption amount T to the sum of the energy losses of the drive unit calculated from the current power consumption amount P.

In a case where the amount of power variation which is a difference between the previous power consumption amount T and the current power consumption amount P is equal to or less than a first threshold, the machining condition information generation unit 31 may not change the machining condition such as the amount of override. In a case where the amount of energy loss variation which is a difference between the energy losses of the motor or the drive unit calculated from the previous power consumption amount T and the energy losses of the motor or the drive unit calculated from the current power consumption amount P is equal to or less than a second threshold, the machining condition information generation unit 31 may not change the machining condition such as the amount of override. Consequently, the numerical control machining system 1A can avoid a phenomenon in which a vibrational behavior of a value of the machining condition occurs in the vicinity of the optimum value of the machining condition, and can resume adjustment in a case where an optimum condition changes while the machining is repeated for a long period of time.

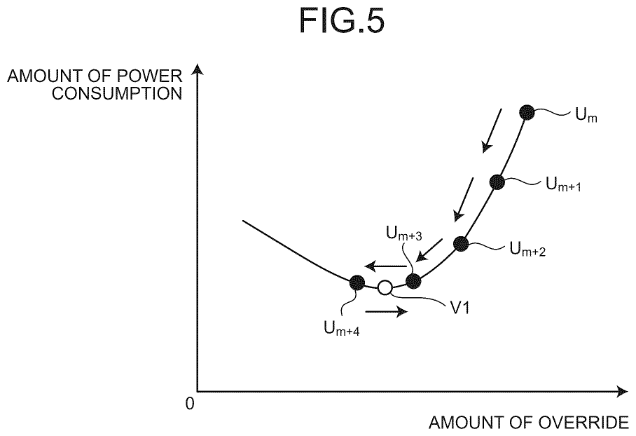

FIG. 5 is a diagram for explaining the process in which the numerical control machining system according to the first embodiment adjusts the amount of override. The horizontal axis of a graph illustrated in FIG. 5 represents the amount of override, and the vertical axis represents the amount of power consumption. In FIG. 5, the amount of power consumption in m-th (m is a natural number) machining is illustrated as a power consumption amount Uₘ.

Similarly, the amounts of power consumption in (m+1)th to (m+4)th machining are illustrated as power consumption amounts Uₘ₊₁ to Uₘ₊₄. In addition, the minimum value which is the optimum value of the power consumption is illustrated as a power minimum V1.

The power consumption amount adjustment device 30A of the numerical control machining system 1A determines whether the current power consumption amount P is equal to or less than the previous power consumption amount T. That is, the power consumption amount adjustment device 30A determines whether the power consumption amount Uₘ₊₁ in the (m+1)th machining is equal to or less than the power consumption amount Uₘ in the m-th machining. In a case where the power consumption amount Uₘ₊₁ in the (m+1)th machining is equal to or less than the power consumption amount Uₘ in the m-th machining, the power consumption amount adjustment device 30A decreases the amount of override.

Similarly, in a case where the power consumption amount Uₘ₊₂ in the (m+2)th machining is equal to or less than the power consumption amount Uₘ₊₁ in the (m+1)th machining, the power consumption amount adjustment device 30A decreases the amount of override. Furthermore, in a case where the power consumption amount Uₘ₊₃ in the (m+3)th machining is equal to or less than the power consumption amount Uₘ₊₂ in the (m+2)th machining, the power consumption amount adjustment device 30A decreases the amount of override.

On the other hand, in a case where the power consumption amount Uₘ₊₄ in the (m+4)th machining is larger than the power consumption amount Uₘ₊₃ in the (m+3)th machining, the power consumption amount adjustment device 30A increases the amount of override.

As described above, the power consumption amount adjustment device 30A adjusts the amount of override so that the amount of power consumption decreases. The power consumption amount adjustment device 30A repeats the adjustment of the amount of override to thereby approximate the amount of power consumption to the power minimum V1 which is the optimum value. Consequently, the power consumption amount adjustment device 30A adjusts the amount of power consumption.

Note that the machining condition information generation unit 31 may select and adjust only one machining condition to be adjusted depending on the workpiece 21 or the machine tool device 50, or may simultaneously adjust a plurality of machining conditions.

The machining condition information generation unit 31 may sequentially adjust the machining conditions one by one in such a way that, when adjustment of one specific machining condition is completed, then next one specific machining condition is adjusted. For example, in a case where N (N is a natural number of 2 or more) types of machining conditions are optimized, after adjusting the machining conditions from a first type to an N-th type thereof in order, the machining condition information generation unit 31 may again adjust the machining conditions from the first type to the N-th type thereof. That is, the machining condition information generation unit 31 may repeat the process of adjusting the machining conditions from the first type to the N-th type thereof a plurality of times.

As described above, the numerical control machining system 1A of the first embodiment calculates the amount of power consumption with respect to the amount of override set on the basis of the machining program. Then, the numerical control machining system 1A changes the amount of override by a specific rate only, and calculates the amount of power consumption at the time of performing the machining program operation by using the changed amount of override. The numerical control machining system 1A compares the calculated current power consumption amount P with the previous power consumption amount T with respect to the amount of override set on the basis of the machining program of the previous machining. The numerical control machining system 1A increases the amount of override in a case where the current power consumption amount P is larger than the previous power consumption amount T, and decreases the amount of override in a case where the current power consumption amount P is equal to or less than the previous power consumption amount T. Consequently, the numerical control machining system 1A can approximate the amount of override to the optimum value while reducing the amount of power consumption.

The numerical control machining system 1A does not need to identify in advance the coefficient of the power consumption per unit time of a feed shaft driving motor, which is difficult to accurately identify, and the coefficient of the power consumption per unit time of the peripheral instruments operating at a constant power, in order to adjust the amount of power consumption. In addition, the numerical control machining system 1A does not need to calculate a cycle time in a case where the machining condition is changed, which is difficult to accurately calculate, and does not need to calculate the amount of power consumption from a predicted value of a machining time. That is, the numerical control machining system 1A can determine the machining condition that can reduce the amount of power consumption without calculating the coefficients of the power consumption per unit time and the cycle time, which are difficult to calculate. Therefore, the numerical control machining system 1A can easily realize reduction in the amount of power consumption with a simple process.

The machine tool device 50 includes, as motors involved in machining, various motors such as the spindle motor 14S that rotates the spindle portion 36S, the servo motors (the X-axis motor 14X, the Y-axis motor 14Y, and the Z-axis motor 14Z) that drive the workpiece 21 and the spindle portion 36S, and a motor (not illustrated) that drives a peripheral shaft of a tool changer or the like.

When the amount of override is changed, the rotation speeds of the servo motors are changed, but the speeds of the spindle motor 14S and the peripheral shaft motor are not changed. In addition, when the amount of override of the spindle portion 36S is changed, the rotation speed of the spindle motor 14S is changed, i.e., the amounts of change and the corresponding motors are different from those in a case where the machining condition is changed. That is, since the parameters of the servo motors, the peripheral shaft motor, and the spindle motor 14S are different from each other, the change in the amount of override does not always affect all the motors.

For example, in a case where a target of the current change is only the amount of override, the power consumption amount adjustment device 30A only needs to acquire and adjust the current power consumption amount P (W) of each servo motor belonging to the machine tool device 50. In that case, the power consumption amount adjustment device 30A acquires an angular velocity ω (rad/s)=2π×N from a motor speed N (rev/s), acquires Tq (motor torque)=Jm (motor inertia)×dω/dt (differentiation of angular velocity), and calculates the current power consumption amount P (W) of the servo motor by the current power consumption amount P (W) of the servo motor=Tq (motor torque)×ω (angular velocity).

There are various devices that consume energy, such as a motor and a drive unit. For example, in a case where it is desired to reduce the heat generation of a control panel, the power consumption amount adjustment device 30A only needs to perform adjustment by using the sum of the amounts of power consumption of a drive unit attached in the control panel. In a case where it is desired to reduce the amount of heat generation of a motor, the power consumption amount adjustment device 30A can adjust the heat generation of the motor by using the sum of the amounts of power consumption of the motor. The power consumption amount adjustment device 30A may normally use reactive power or apparent power instead of power consumption.

As described above, the machining condition information generation unit 31 determines the machining condition change amount R by, for example, multiplying the current machining condition W by an increase/decrease rate of the sum of the energy losses of the motor or the drive unit of the current machining from that of the previous machining.

The power consumption amount adjustment device 30A according to the first embodiment is implemented as software of a computer connected to the numerical control machine tool 100A via a network. Note that the power consumption amount adjustment device 30A may be a computer such as a personal computer (PC) installed in the vicinity of the numerical control machine tool 100A, may be a server connected to a network in a factory where the numerical control machine tool 100A is installed, or may be implemented in a cloud installed at a remote location. The power consumption amount adjustment device 30A may be software of a tablet PC or a smartphone connected to the numerical control machine tool 100A via a wireless network.

As described above, according to the first embodiment, the power consumption amount adjustment device 30A determines the machining condition of the next machining on the basis of the previous power consumption amount T, the current power consumption amount P, and the current machining condition W so that the amount of power consumption in the next machining becomes equal to or less than the current power consumption amount P, and therefore, it is possible to easily realize reduction in the amount of power consumption with a simple process.

### Second Embodiment

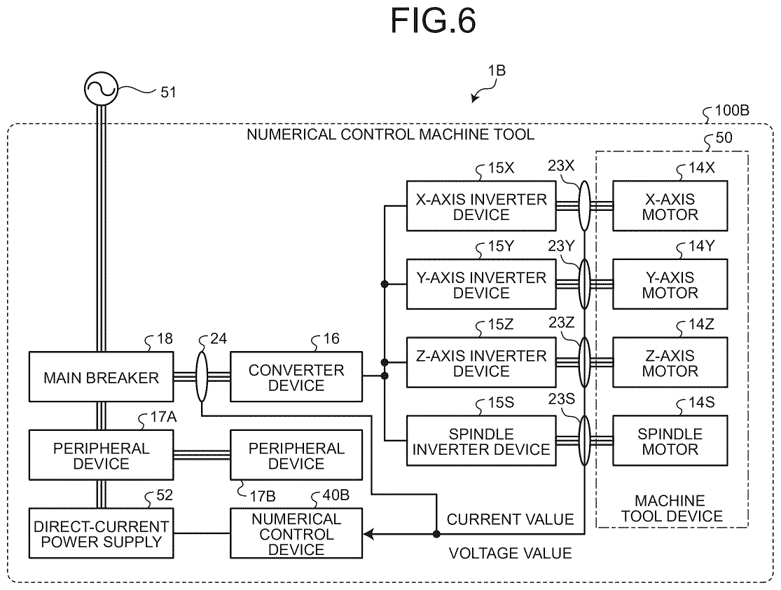

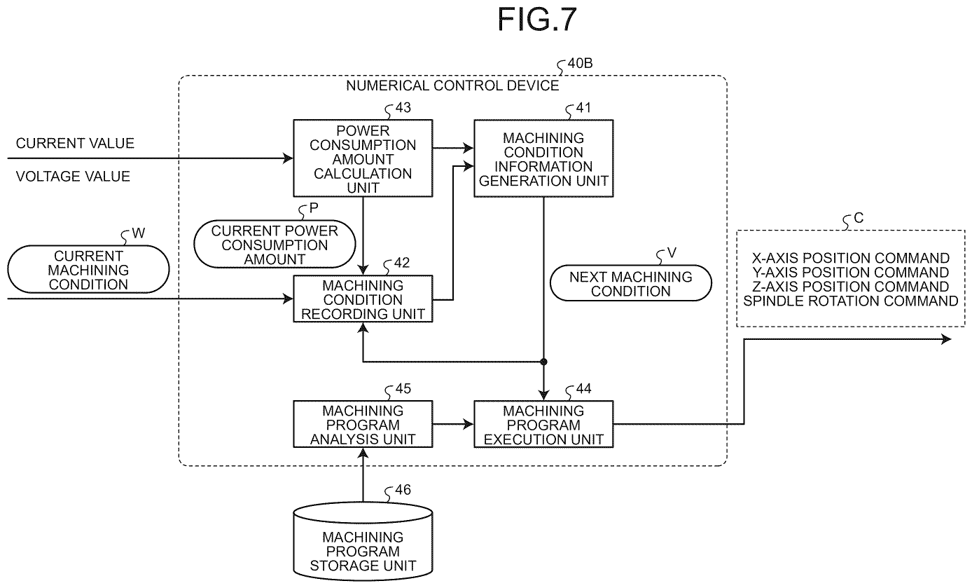

Next, a second embodiment will be described with reference to FIGS. 6 and 7. In the second embodiment, current values and voltage values of respective motors and the converter device 16 are sent to a numerical control device, and the numerical control device adjusts power consumption on the basis of the current values and the voltage values of the respective motors and the converter device 16.

FIG. 6 is a block diagram illustrating a configuration of a numerical control machine tool according to the second embodiment. Regarding components among components in FIG. 6 that achieve the same functions as those of the numerical control machine tool 100A of the first embodiment illustrated in FIG. 2, the same reference signs are assigned thereto, and repetitive descriptions thereof will be omitted.

Compared with the numerical control machine tool 100A, a numerical control machine tool 100B of the second embodiment includes a numerical control device 40B instead of the numerical control device 40A. That is, the numerical control machine tool 100B has a configuration similar to that of the numerical control machine tool 100A, but includes not the numerical control device 40A but the numerical control device 40B.

The numerical control machine tool 100B also includes current/voltage detection units 24, 23X, 23Y, 23Z, and 23S. The current/voltage detection unit 24 is disposed on a connection line connecting the main breaker 18 and the converter device 16, and detects a current value and a voltage value to be input to the converter device 16. The current/voltage detection unit 24 sends the detected current value and voltage value to the numerical control device 40B.

The current/voltage detection units 23X, 23Y, 23Z, and 23S are disposed on connection lines connecting the inverter devices and the motors, and detect current values and voltage values to be input from the inverter devices to the motors. Specifically, the current/voltage detection unit 23X is disposed on a connection line connecting the X-axis inverter device 15X and the X-axis motor 14X, and detects a current value and a voltage value to be input from the X-axis inverter device 15X to the X-axis motor 14X. The current/voltage detection unit 23Y is disposed on a connection line connecting the Y-axis inverter device 15Y and the Y-axis motor 14Y, and detects a current value and a voltage value to be input from the Y-axis inverter device 15Y to the Y-axis motor 14Y. The current/voltage detection unit 232 is disposed on a connection line connecting the Z-axis inverter device 15Z and the Z-axis motor 142, and detects a current value and a voltage value to be input from the Z-axis inverter device 15Z to the Z-axis motor 14Z. The current/voltage detection unit 23S is disposed on a connection line connecting the spindle inverter device 15S and the spindle motor 14S, and detects a current value and a voltage value to be input from the spindle inverter device 15S to the spindle motor 14S. The current/voltage detection units 23X, 23Y, 23Z, and 23S send the detected current values and voltage values to the numerical control device 40B.

The numerical control device 40B has the function of the numerical control device 40A and the function of the power consumption amount adjustment device 30A. The numerical control machine tool 100B is connected to the main power supply 51, but is not connected to the power consumption amount adjustment device 30A. That is, a numerical control machining system 1B of the second embodiment does not include the power consumption amount adjustment device 30A.

FIG. 7 is a block diagram illustrating a configuration of the numerical control device according to the second embodiment. The numerical control device 40B includes a machining condition information generation unit 41, a machining condition recording unit 42, a power consumption amount calculation unit 43, a machining program execution unit 44, and a machining program analysis unit 45.

The machining condition information generation unit 41 has a function similar to that of the machining condition information generation unit 31. The machining condition recording unit 42 has a function similar to that of the machining condition recording unit 32. The power consumption amount calculation unit 43 is connected to the machining condition information generation unit 41 and the machining condition recording unit 42. The machining condition information generation unit 41 is connected to the machining condition recording unit 42 and the machining program execution unit 44. The machining program execution unit 44 is connected to the machining program analysis unit 45.

The machining program analysis unit 45 is connected to a machining program storage unit 46 disposed outside the numerical control device 40B, and reads a machining program from the machining program storage unit 46. Note that the machining program storage unit 46 may be disposed inside the numerical control device 40B.

The power consumption amount calculation unit 43 receives current values and voltage values from the current/voltage detection units 24, 23X, 23Y, 23Z, and 23S. The power consumption amount calculation unit 43 calculates the current power consumption amount P from the received current values and voltage values.

Specifically, the power consumption amount calculation unit 43 calculates the amount of power consumption of the converter device 16 from the current value and the voltage value received from the current/voltage detection unit 24. The power consumption amount calculation unit 43 calculates the amount of power consumption of the X-axis motor 14X from the current value and the voltage value received from the current/voltage detection unit 23X, and calculates the amount of power consumption of the Y-axis motor 14Y from the current value and the voltage value received from the current/voltage detection unit 23Y. The power consumption amount calculation unit 43 calculates the amount of power consumption of the Z-axis motor 14Z from the current value and the voltage value received from the current/voltage detection unit 232, and calculates the amount of power consumption of the spindle motor 14S from the current value and the voltage value received from the current/voltage detection unit 23S.

As described above, the power consumption amount calculation unit 43 calculates the current power consumption amount P from the measured values of the current values and the voltage values of the motors and the converter device 16. The inverter devices and the converter device 16 use sensors implemented in the inverter devices and the converter device 16 to monitor current values and voltage values to be input and output in order to control motor currents as commanded, and perform feedback control. That is, the inverter devices each use the sensor to monitor the current value and the voltage value to be input, and perform feedback control. The converter device 16 uses the sensor to monitor the current value and the voltage value to be output, and performs feedback control. Information on the current values, the voltage values, and the like used for the feedback control is transmitted to the numerical control device 40B, and the numerical control device 40B uses the information to calculate the current power consumption amount P at the time of executing the machining program.

Note that the current power consumption amount P may be calculated by using microcomputers inside the inverter devices and the converter device 16. Information of a measuring instrument such as a clamp meter instead of the sensors inside the inverter devices and the converter device 16 may be directly transmitted to the numerical control device 40B, and the numerical control device 40B may calculate the current power consumption amount P.

The power consumption amount calculation unit 43 sends each of the current power consumption amounts P calculated on a per device basis to the machining condition recording unit 42. That is, the power consumption amount calculation unit 43 sends the current power consumption amount P of the converter device 16, the current power consumption amount P of the X-axis motor 14X, the current power consumption amount P of the Y-axis motor 14Y, the current power consumption amount P of the Z-axis motor 142, and the current power consumption amount P of the spindle motor 14S to the machining condition information generation unit 41 and the machining condition recording unit 42.

The machining condition recording unit 42 records the current power consumption amount P at the time of current execution of the machining program and the current machining condition W corresponding to the current power consumption amount P on a per device basis. That is, the machining condition recording unit 42 records the amount of power consumption and the machining condition of each machining on a per device basis. When the machining condition recording unit 42 records the amount of power consumption and the machining condition of the next machining anew, the current power consumption amount P and the current machining condition W that have been already recorded become the previous power consumption amount T and the previous machining condition.

The machining condition information generation unit 41 compares the previous power consumption amount T and the current power consumption amount P on a per device basis, and generates, on the basis of a result of the comparison, a next machining condition V at a time of next execution of the machining program on a per device basis.

That is, the machining condition information generation unit 41 determines the next machining condition V so that the amount of power consumption at the time of the next execution of the machining program (next power consumption amount) becomes lower than the current power consumption amount P at the time of the current execution of the machining program. In the second embodiment, the machining condition information used for the next machining is the next machining condition V.

In the second embodiment, the machining condition information generation unit 41 adjusts the amount of power consumption by adjusting, for example, a PWM carrier frequency as the machining condition related to the amount of power consumption. A lower PWM carrier frequency does not necessarily result in a lower amount of power consumption, and there is a PWM carrier frequency at which the amount of power consumption can be minimized. The PWM carrier frequency for making the amount of power consumption the optimum value varies depending on the machining condition.

The machining condition information generation unit 41 sends the determined next machining condition V to the machining program execution unit 44 and the machining condition recording unit 42. The machining condition recording unit 42 records the next machining condition V.

The machining program analysis unit 45 reads the machining program from the machining program storage unit 46 and analyzes the machining program. The machining program analysis unit 45 sends an analysis result to the machining program execution unit 44.

The analysis result obtained as a result of the analysis by the machining program analysis unit 45 is, for example, the amount of power consumption at the time of acceleration/deceleration, the amount of power consumption in a case where the machining program is executed for a specific period, and the amount of power consumption in a case where the machining program is executed for one cycle. The machining program execution unit 44 executes

the machining program by using the next machining condition V sent from the machining condition information generation unit 41 and the analysis result sent from the machining program analysis unit 45. For example, on the basis of the amount of power consumption at the time of acceleration/deceleration, the machining program execution unit 44 calculates a position command under the next machining condition V on a per device basis. That is, the machining program execution unit 44 outputs a command C directed to each device by executing the machining program. The command C includes a position command of each feed shaft and a rotation command to the spindle. Specifically, the command C includes an X-axis position command, a Y-axis position command, a Z-axis position command, and a spindle rotation command.

Note that processing units (the machining condition information generation unit 41, the machining condition recording unit 42, and the power consumption amount calculation unit 43) that execute adjustment of the amount of power consumption may be implemented as software executed by a central processing unit (CPU) inside the numerical control device 40B, or may be implemented as hardware such as an application specific integrated circuit (ASIC) or a field programmable gate array (FPGA).

As described above, in the second embodiment, the current values and the voltage values of the respective motors and the converter device 16 are input to the numerical control device 40B, and the numerical control device 40B executes adjustment of the amount of power consumption. Consequently, the numerical control device 40B can easily realize reduction in the amount of power consumption with a simple process without using the power consumption amount adjustment device 30A.

### Third Embodiment

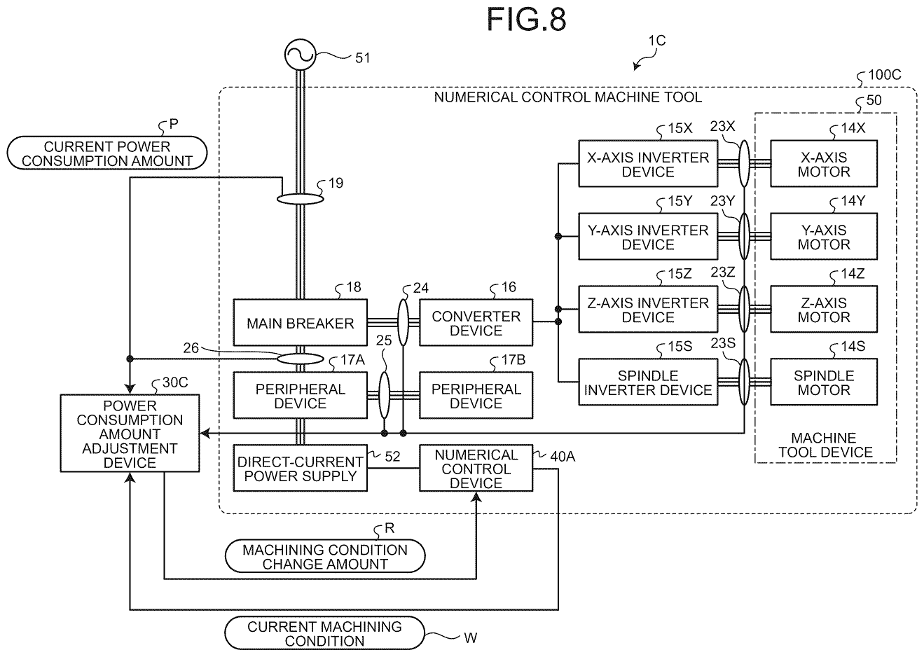

Next, a third embodiment will be described with reference to FIG. 8. A power consumption amount adjustment device of the third embodiment monitors the amount of power consumption of the main breaker 18, and calculates the amount of power consumption on the basis of current values and voltage values of respective motors, the converter device 16, and the peripheral devices 17A and 17B. The power consumption amount adjustment device of the third embodiment executes adjustment of power consumption on the basis of a plurality of types of power measurement results (power consumption).

FIG. 8 is a block diagram illustrating a configuration of a numerical control machining system including the power consumption amount adjustment device according to the third embodiment. Regarding components among components in FIG. 8 that achieve the same functions as those of the numerical control machine tool 100A of the first embodiment illustrated in FIG. 2 or the numerical control machine tool 100B of the second embodiment illustrated in FIG. 6, the same reference signs are assigned thereto, and repetitive descriptions thereof will be omitted.

A numerical control machining system 1C includes a power consumption amount adjustment device 300 and a numerical control machine tool 100C. The numerical control machine tool 100C includes components included in the numerical control machine tool 100A, and current/voltage detection units 24, 23X, 23Y, 23Z, 23S, 25, and 26.

The current/voltage detection unit 25 is disposed on a connection line connecting the peripheral device 17A and the peripheral device 17B, and detects a current value and a voltage value to be input to the peripheral device 17B. The current/voltage detection unit 25 sends the detected current value and voltage value to the power consumption amount adjustment device 30C.

The current/voltage detection unit 26 is disposed on a connection line connecting the main breaker 18 and the peripheral device 17A, and detects a current value and a voltage value to be input to the peripheral device 17A. The current/voltage detection unit 26 sends the detected current value and voltage value to the power consumption amount adjustment device 30C.

Similarly to the first embodiment, the power consumption detection unit 19 detects the amount of power consumption of the numerical control machine tool 100C, and sends the detected amount of power consumption to the power consumption amount adjustment device 30C. Similarly to the second embodiment, the current/voltage detection units 23X, 23Y, 232, and 23S detect current values and voltage values to be input from the inverter devices to the motors, and send the detected current values and voltage values to the power consumption amount adjustment device 30C.

As described above, in the numerical control machining system 1C, the amount of power consumption of the main breaker 18 is monitored, and the current values and the voltage values of the respective motors and the converter device 16, and the current values and the voltage values of the peripheral devices 17A and 17B are input to the power consumption amount adjustment device 30C. The power consumption amount adjustment device 30C adjusts the amount of power consumption on the basis of the amount of power consumption of the main breaker 18, the current values and the voltage values of the respective motors and the converter device 16, and the current values and the voltage values of the peripheral devices 17A and 17B.

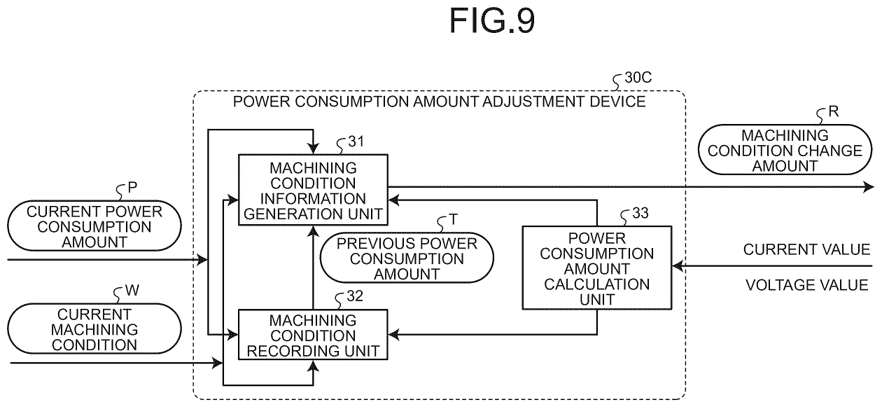

FIG. 9 is a block diagram illustrating a configuration of the power consumption amount adjustment device according to the third embodiment. The power consumption amount adjustment device 30C includes components included in the power consumption amount adjustment device 30A and a power consumption amount calculation unit 33. That is, the power consumption amount adjustment device 30C includes the machining condition information generation unit 31, the machining condition recording unit 32, and the power consumption amount calculation unit 33.

The power consumption amount calculation unit 33 has a function similar to that of the power consumption amount calculation unit 43 included in the numerical control device 40B. The power consumption amount calculation unit 33 is connected to the machining condition information generation unit 31 and the machining condition recording unit 32.

Similarly to the power consumption amount calculation unit 43, the power consumption amount calculation unit 33 receives current values and voltage values from the current/voltage detection units 24, 23X, 23Y, 23Z, 23S, 25, and 26. The power consumption amount calculation unit 33 calculates the amounts of power consumption from the received current values and voltage values.

Specifically, the power consumption amount calculation unit 33 calculates the amount of power consumption of the converter device 16 from the current value and the voltage value received from the current/voltage detection unit 24. The power consumption amount calculation unit 33 calculates the amounts of power consumption of the X-axis motor 14X, the Y-axis motor 14Y, the Z-axis motor 14Z, and the spindle motor 14S from the current values and the voltage values received from the current/voltage detection units 23X, 23Y, 23Z, and 23S. The power consumption amount calculation unit 33 calculates the amount of power consumption of the peripheral device 17B from the current value and the voltage value received from the current/voltage detection unit 25. The power consumption amount calculation unit 33 calculates the amount of power consumption of the peripheral device 17A from the current value and the voltage value received from the current/voltage detection unit 26.

The power consumption amount calculation unit 33 sends the calculated amounts of power consumption to the machining condition information generation unit 31 and the machining condition recording unit 32. The machining condition information generation unit 31 and the machining condition recording unit 32 receive the amounts of power consumption of the converter device 16, the X-axis motor 14X, the Y-axis motor 14Y, the Z-axis motor 14Z, the spindle motor 14S, and the peripheral devices 17A and 17B from the power consumption amount calculation unit 33.

Similarly to the power consumption amount adjustment device 30A, the machining condition information generation unit 31 and the machining condition recording unit 32 receive the current power consumption amount P from the power consumption detection unit 19, and receive the current machining condition W from the numerical control device 40A. The machining condition information generation unit 31 calculates the machining condition change amount R on the basis of the current power consumption amount P, the previous power consumption amount T, and the current machining condition W, and outputs the machining condition change amount R to the numerical control device 40A. In the third embodiment, the machining condition information used for the next machining is the machining condition change amount R.

Note that the amounts of power consumption may be calculated by using microcomputers inside the inverter devices, the converter device 16, and the peripheral devices 17A and 17B. Information of a measuring instrument such as a clamp meter instead of the sensors inside the inverter devices, the converter device 16, and the peripheral devices 17A and 17B may be transmitted to the power consumption amount adjustment device 30C, and the power consumption amount adjustment device 30C may calculate the amounts of power consumption.

The power consumption amount calculation unit 33 calculates at least one of the following amounts of power consumption (p1) to (p5) from the start of execution of the machining program to the end of execution of the machining program as the amount of power consumption of the numerical control machine tool 100C.
(p1) The sum of the amounts of power consumption of one or more motors driven by the numerical control machine tool 100C
(p2) The sum of the amounts of power consumption of one or more inverter devices that perform servo control of the motors
(p3) The sum of the amounts of power consumption of one or more converter devices that supply power to the inverter devices
(p4) The sum of the amounts of power consumption of one or more peripheral devices
(p5) The amount of power consumption of the main power supply 51 that inputs power to the numerical control machine tool 100C

In a case of using a plurality of power measurement results (the amounts of power consumption) acquired by the power consumption amount calculation unit 33, the machining condition information generation unit 31 of the third embodiment may adjust the amounts of power consumption for a plurality of elements included in the numerical control machine tool 100C. The machining condition information generation unit 31 may adjust the amount of power consumption for each shaft driven by the numerical control machine tool 100C, for example. In addition, the machining condition information generation unit 31 may adjust the amount of power consumption by combining a method in which the amount of power consumption is adjusted for each shaft driven by the numerical control machine tool 100C and a method in which the peripheral devices 17A and 17B are controlled depending on a condition of use.

In a case where the amount of power consumption is adjusted for each shaft driven by the numerical control machine tool 100C, the machining condition information generation unit 31 adjusts the amount of power consumption of each shaft by adjusting at least one of the amount of override of a motor during machining, an acceleration time constant, a feed speed, a spindle rotation speed, and a PWM carrier frequency for each shaft driven by the numerical control machine tool 100C.

Note that the numerical control device 40A may have the function of the power consumption amount adjustment device 30C. In that case, the numerical control device 40A has a function similar to that of the numerical control device 40B described in the second embodiment.

As described above, the numerical control machining system 1C of the third embodiment adjusts the plurality of elements included in the numerical control machine tool 100C on the basis of the plurality of power measurement results, so that various adjustments can be made to the plurality of elements easily and in detail. Therefore, the numerical control machining system IC can adjust the amount of power consumption in a short time. Fourth Embodiment.

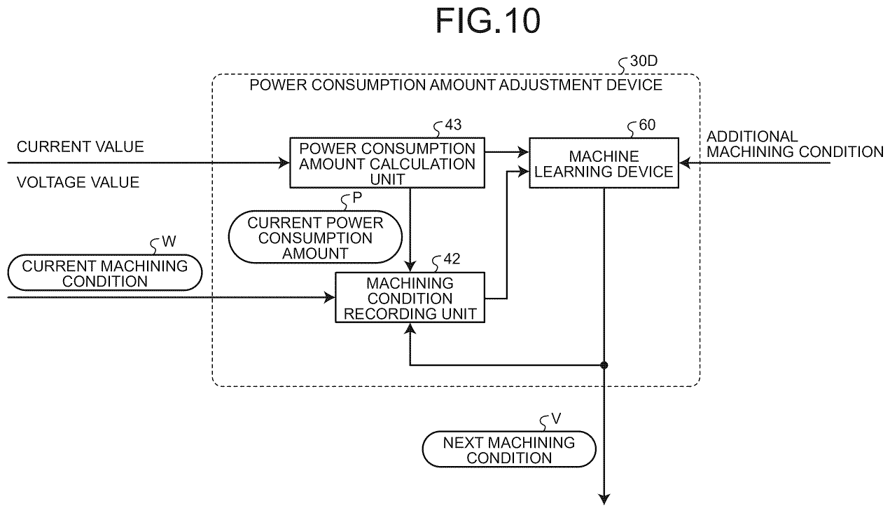

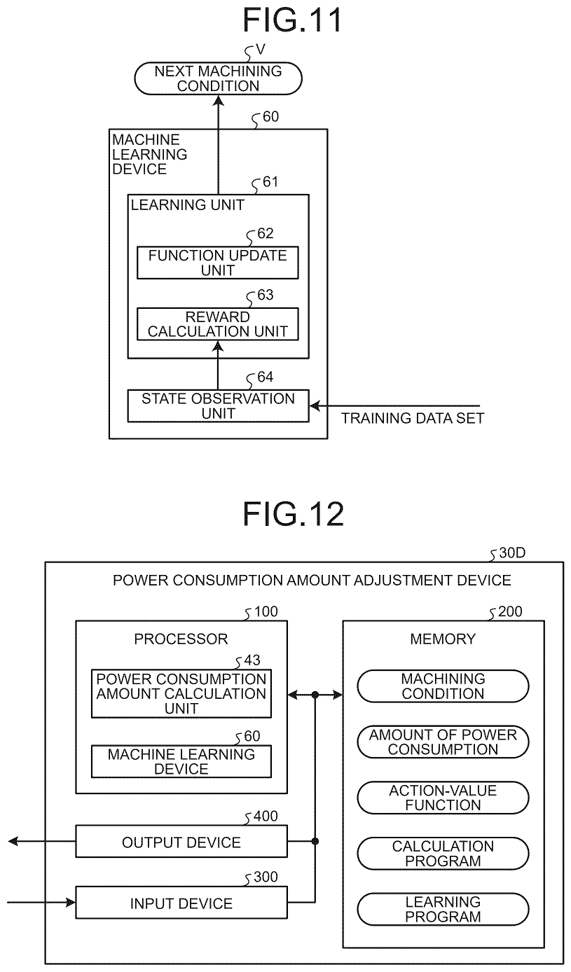

Next, a fourth embodiment will be described with reference to FIGS. 10 and 11. In the fourth embodiment, a power consumption amount adjustment device includes a machine learning device as a machining condition information generation unit, and the machine learning device learns a machining condition for adjusting the amount of power consumption. Note that in the fourth embodiment, a case will be described where the machine learning device is applied to the numerical control machining system 1C, but the machine learning device may be applied to the numerical control machining systems 1A and 1B.

FIG. 10 is a block diagram illustrating a configuration of a power consumption amount adjustment device according to the fourth embodiment. Regarding components among components in FIG. 10 that achieve the same functions as those of the power consumption amount adjustment device 30C of the third embodiment illustrated in FIG. 9, the same reference signs are assigned thereto, and repetitive descriptions thereof will be omitted.

A power consumption amount adjustment device 30D of the fourth embodiment includes the power consumption amount calculation unit 43, the machining condition recording unit 42, and a machine learning device 60 which is a machining condition information generation unit. The power consumption amount calculation unit 43 records, in the machining condition recording unit 42, the current power consumption amount P calculated on the basis of the current values and the voltage values sent from the current/voltage detection units 24, 23X, 23Y, 232, and 23S, and the like. The machining condition recording unit 42 records the current machining condition W and the current power consumption amount P in association with each other. When the machining condition recording unit 42 records a new current power consumption amount P, the current power consumption amount P that has been already recorded becomes the previous power consumption amount T.

The machine learning device 60 reads the current machining condition W, the current power consumption amount P, and the previous power consumption amount T (not illustrated in FIG. 10) from the machining condition recording unit 42. An additional machining condition which is additional information of the machining condition is input to the machine learning device 60.

The additional machining condition is a machining condition to be added in order to enhance the accuracy of learning. Examples of the additional machining condition include a shape of the workpiece 21, a material of the workpiece 21, a tool diameter, a tool material, a tool shape, the number of blades, a feed amount per blade, a rotation speed of the tool 20, information on a mechanical structure of the machine tool device 50, information on tool friction, and tool usage time. The information on the mechanical structure of the machine tool device 50 is information characterizing the configuration of the machine tool device 50.

In a case of receiving the additional machining condition, the machine learning device 60 includes the additional machining condition in the current machining condition W. In that case, the machining condition of each machining includes the additional machining condition. Note that the additional machining condition may not be input to the machine learning device 60.

The current machining condition W, the current power consumption amount P, and the previous power consumption amount T received by the machine learning device 60 correspond to a training data set. The machine learning device 60 learns a relationship between the power consumption and the machining condition in accordance with the training data set, and outputs the next machining condition V. In the fourth embodiment, the machining condition information used for the next machining is the next machining condition V.

The machine learning device 60 calculates and outputs the next machining condition V under which the amount of power consumption becomes smaller than the current power consumption amount P. The machine learning device 60 outputs the next machining condition V to the numerical control machine tool 100C and the machining condition recording unit 42.

Consequently, the numerical control machine tool 100C executes the next machining by using the next machining condition V. The machining condition recording unit 42 records the next machining condition V output from the machine learning device 60. When machining is executed by using the next machining condition V, the next machining condition V recorded by the machining condition recording unit 42 becomes the current machining condition W. In addition, the amount of power consumption at the time of machining by using the next machining condition V becomes the current power consumption amount P.

As described above, in a case where the machine learning device 60 calculates the next machining condition V by using the additional machining condition, the additional machining condition is included in the current machining condition W. That is, the additional machining condition is included in a condition item of the current machining condition W. In a case where the machine learning device 60 calculates the next machining condition V by using the current machining condition W including the additional machining condition, the next machining condition V includes a condition item included in the current machining condition W and a condition item included in the additional machining condition. On the other hand, in a case where the machine learning device 60 calculates the next machining condition V by using the current machining condition W that does not include the additional machining condition, the next machining condition V does not include the condition item included in the additional machining condition.

FIG. 11 is a block diagram illustrating a configuration of the machine learning device included in the power consumption amount adjustment device according to the fourth embodiment. The machine learning device 60 includes a learning unit 61 and a state observation unit 64. The state observation unit 64 observes, as a state variable, a training data set including the current power consumption amount P, the previous power consumption amount T, and the current machining condition W. The state observation unit 64 sends a training data set created on the basis of the state variable to the learning unit 61.

The learning unit 61 learns the relationship between the power consumption and the machining condition in accordance with the training data set created on the basis of the state variable. The learning unit 61 may use any learning algorithm. Here, a case will be described where reinforcement learning is applied to the learning algorithm.

Reinforcement learning is learning in which an agent as a subject of action in a certain environment observes the current state indicated by a state variable, and decides what action to take on the basis of a result of the observation. The agent gets a reward from the environment by selecting an action, and learns a policy with which a maximum reward is obtained through a series of actions. As representative methods of reinforcement learning, Q-learning, TD-learning, and the like are known.

For example, in a case of Q-learning, an action-value table which is a general update formula for an action-value function Q(s,a) is expressed by the following formula (1). The action-value function Q(s,a) indicates an action value Q which is a value of an action of selecting an action “a” under an environment “s”.

$$\begin{matrix}Formula 1 & \\ Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) & ( 1 )\end{matrix}$$

In the formula (1), “Sₜ₊₁” represents an environment at time “t”. “at” represents an action at time “t”. The action “at” changes the environment to “Sₜ₊₁”. “rₜ₊₁” represents a reward given by the change in the environment. “γ” represents a discount rate. “α” represents a learning coefficient. In a case where Q-learning is applied, the current machining condition w corresponds to the action “aₜ”.

The update formula expressed by the above formula (1) increases an action value Q if an action value of best action “a” at time “t+1” is larger than an action value Q of action “a” executed at time “t”, and decreases the action value Q in the opposite case. In other words, the action-value function Q(s,a) is updated so as to approximate the action value Q of action “a” at time “t” to a best action value at time “t+1”. Consequently, a best action value in a certain environment is sequentially propagated to action values in the previous environments.

The learning unit 61 includes a function update unit 62 and a reward calculation unit 63. The reward calculation unit 63 calculates a reward on the basis of a state variable. The function update unit 62 updates a function for determining the machining condition (next machining condition V) in accordance with the reward calculated by the reward calculation unit 63.

Specifically, the reward calculation unit 63 calculates a reward “r” on the basis of the current power consumption amount P and the previous power consumption amount T. For example, in a case where the current power consumption amount P becomes equal to or less than the previous power consumption amount T as a result of changing the machining condition from the previous machining condition to the current machining condition w, the reward calculation unit 63 increases the reward “r”. The reward calculation unit 63 increases the reward “r”, for example, by giving “1” which is a value of the reward. Note that the value of the reward is not limited to “1”.

In a case where the current power consumption amount P becomes larger than the previous power consumption amount T as a result of changing the machining condition from the previous machining condition to the current machining condition W, the reward calculation unit 63 decreases the reward “r”. The reward calculation unit 63 decreases the reward “r”, for example, by giving “−1” which is a value of the reward. Note that the value of the reward is not limited to “−1”.

In a case where the current power consumption amount P and the previous power consumption amount T become the same as a result of changing the machining condition from the previous machining condition to the current machining condition W, the reward calculation unit 63 does not change the reward “r”. The reward calculation unit 63 does not change the reward “r”, for example, by giving “0” which is a value of the reward. Note that the value of the reward is not limited to “o”.

The learning unit 61 acquires, from the current machining condition W, the next machining condition V under which it is predicted that the amount of power consumption in the next machining can be reduced to be lower than the current power consumption amount P.

The function update unit 62 updates a function which is a determination model for determining the next machining condition V in accordance with the reward calculated by the reward calculation unit 63. The function can be updated in accordance with the training data set, for example, by updating the action-value table. The action-value table is a data set in which any action and an action value thereof are stored in association with each other in a form of a table. For example, in the case of Q-learning, an action-value function Q(sₜ, aₜ) expressed by the above formula is used as a function for determining the next machining condition V.

So far, the case has been described where reinforcement learning is applied to the learning algorithm used by the learning unit 61, but learning other than reinforcement learning may be applied to the learning algorithm. The learning unit 61 may execute machine learning by using a known learning algorithm other than reinforcement learning, for example, a learning algorithm such as deep learning, a neural network, genetic programming, inductive logic programming, or a support vector machine.

The learning unit 61 may construct a training data set including information on all shafts of the numerical control machine tool 100C and learn a determination model for determining the next machining condition V, or may construct a training data set for each shaft of the numerical control machine tool 100C and learn a determination model for each shaft for determining the next machining condition V.

The learning unit 61 is not limited to one built into the power consumption amount adjustment device 30D. The learning unit 61 may be realized by a device outside the power consumption amount adjustment device 30D. In that case, the device functioning as the learning unit 61 may be a device connectable to the power consumption amount adjustment device 30D via a network. The device functioning as the learning unit 61 may be a device residing on a cloud server.

In a case where the machine learning device 60 is applied to the numerical control machining system 1A, the training data set includes the machining condition change amount R applied to the current machining instead of the current machining condition W. The machine learning device 60 calculates and outputs the machining condition change amount R to be applied to the next machining instead of the next machining condition V. That is, the machine learning device 60 learns the relationship between the machining condition and the power consumption on the basis of the machining condition change amount R applied to the current machining, the current power consumption amount P, and the previous power consumption amount T, and calculates and outputs the machining condition change amount R to be applied to the next machining. In a case where the machine learning device 60 is applied to the numerical control machining system 1B, in the numerical control device 40B, the machine learning device 60 is disposed instead of the machining condition information generation unit 41.

Here, a hardware configuration of the power consumption amount adjustment devices 30A, 30C, and 30D and the numerical control device 40B will be described. Since the power consumption amount adjustment devices 30A, 30C, and 30D and the numerical control device 40B have similar hardware configurations, the hardware configuration of the power consumption amount adjustment device 30D will be described here.

FIG. 12 is a diagram illustrating an exemplary hardware configuration that realizes the power consumption amount adjustment device according to the fourth embodiment. The power consumption amount adjustment device 30D can be realized by an input device 300, a processor 100, a memory 200, and an output device 400. Examples of the processor 100 include a central processing unit (CPU, also referred to as a central processing device, a processing device, an arithmetic device, a microprocessor, a microcomputer, and a digital signal processor (DSP)) and system large scale integration (LSI). Examples of the memory 200 include a random access memory (RAM) and a read only memory (ROM).

The power consumption amount adjustment device 30D is realized by the processor 100 reading and executing a computer-executable processing program stored in the memory 200 for executing an operation of the power consumption amount adjustment device 30D. It can also be said that the processing program for executing an operation of the power consumption amount adjustment device 30D causes a computer to execute a procedure or a method of the power consumption amount adjustment device 30D.

The processing program executed by the power consumption amount adjustment device 30D has a modular configuration including the power consumption amount calculation unit 43 and the machine learning device 60, and these are loaded on a main storage device and generated on the main storage device.

The processing program executed by the power consumption amount adjustment device 30D includes a calculation program for calculating the amount of power consumption, and a learning program for learning the machining condition of the next machining.

The input device 300 receives and sends the previous power consumption amount T, the current power consumption amount P, the current machining condition W, and the like, to the processor 100. The memory 200 stores machining conditions, the amounts of power consumption, the action-value function Q(s,a), the calculation program, the learning program, and the like. The memory 200 stores, for example, the previous power consumption amount T, the current power consumption amount P, and the like as the power consumption, and stores the current machining condition W and the like as the machining conditions. The memory 200 stores the latest action-value function Q(s,a).

The calculation program, the learning program, the machining conditions, the amounts of power consumption, and the action-value function Q(s,a) are read from the memory 200 by the processor 100. The memory 200 is also used as a temporary memory when the processor 100 executes various processes.

A process executed by the output device 400 corresponds to a process in which the power consumption amount adjustment device 30D outputs the next machining condition V.

The calculation program and the learning program may be stored in a computer-readable storage medium as a file in an installable format or an executable format and provided as a computer program product. The calculation program and the learning program may be provided to the power consumption amount adjustment device 30D via a network such as the Internet. A part of the functions of the power consumption amount adjustment device 30D may be realized by dedicated hardware such as a dedicated circuit, and another part thereof may be realized by software or firmware.

As described above, according to the fourth embodiment, the power consumption amount adjustment device 30D can determine, by learning the correspondence between the power consumption and the machining conditions, an optimum machining condition even in a situation where various factors affect the amount of power consumption.

The configurations described in the above embodiments are merely examples and can be combined with other known technology, the embodiments can be combined with each other, and part of the configurations can be omitted or modified without departing from the gist thereof.

### REFERENCE SIGNS LIST

1A to 1C numerical control machining system; 14S spindle motor; 14X X-axis motor; 14Y Y-axis motor; 14Z Z-axis motor; 15S spindle inverter device; 15X X-axis inverter device; 15Y Y-axis inverter device; 15Z Z-axis inverter device; 16 converter device; 17A, 17B peripheral device; 18 main breaker; 19 power consumption detection unit; 20 tool; 21 workpiece; 22 table; 23S, 23X, 23Y, 23Z, 24 to 26 current/voltage detection unit; 30A, 30C, 30D power consumption amount adjustment device; 31, 41 machining condition information generation unit; 32, 42 machining condition recording unit; 33, 43 power consumption amount calculation unit; 35X X-axis portion; 35Y Y-axis portion; 35Z Z-axis portion; 36S spindle portion; 40A, 40B numerical control device; 44 machining program execution unit; 45 machining program analysis unit; 46 machining program storage unit; 50 machine tool device; 51 main power supply; 52 direct-current power supply; 60 machine learning device; 61 learning unit; 62 function update unit; 63 reward calculation unit; 64 state observation unit; 100 processor; 100A to 100C numerical control machine tool; 200 memory; 300 input device; 400 output device.

1. A power consumption amount adjustment device that adjusts an amount of power consumption of a numerical control machine tool that drives a motor and performs machining in accordance with a machining program, the power consumption amount adjustment device comprising:
a machining condition information generator to generate, on a basis of a previous power consumption amount that is an amount of power consumption at a time of previous execution of a machining program, a current power consumption amount that is an amount of power consumption at a time of current execution of the machining program, and a current machining condition that is a machining condition at a time of current execution of the machining program and affects the current power consumption amount, machining condition information for determining a next machining condition so that a next power consumption amount that is an amount of power consumption at a time of next execution of the machining program becomes smaller than the current power consumption amount, the next machining condition being a machining condition at a time of next execution of the machining program and affecting the next power consumption amount.

2. The power consumption amount adjustment device according to claim 1, wherein
the machining condition information is an amount of change from the current machining condition to the next machining condition.

3. The power consumption amount adjustment device according to claim 2, wherein
the machining condition information generator compares the previous power consumption amount with the current power consumption amount, and determines an amount of change to the next machining condition on a basis of a comparison result.

4. The power consumption amount adjustment device according to claim 3, wherein
the amount of change is an amount of change in an amount of specific override, and
the machining condition information generator determines the amount of change obtained by increasing the amount of specific override in a case where the current power consumption amount is larger than the previous power consumption amount, and determines the amount of change obtained by decreasing the amount of specific override in a case where the current power consumption amount is smaller than the previous power consumption amount.

5. The power consumption amount adjustment device according to claim 1, wherein
the machining condition information is the next machining condition that is a machining condition at a time of next execution of the machining program.

6. The power consumption amount adjustment device according to claim 1, wherein
the machining condition information includes at least one of pieces of information on an amount of override of a motor during machining, an acceleration time constant, a feed speed, a spindle rotation speed, and a pulse width modulation carrier frequency for each shaft driven by the numerical control machine tool.

7. The power consumption amount adjustment device according to claim 1, wherein
the previous power consumption amount and the current power consumption amount are at least one of a sum of amounts of power consumption of a motor driven by the numerical control machine tool, a sum of amounts of power consumption of an inverter device that performs servo control of the motor, a sum of amounts of power consumption of a converter device that supplies power to the inverter device, a sum of amounts of power consumption of a peripheral device included in the numerical control machine tool, and an amount of power consumption of a main power supply that inputs power to the numerical control machine tool, from start of execution to end of execution of the machining program.

8. The power consumption amount adjustment device according to claim 2, wherein
the amount of change is an amount of change preset for each type of the machining condition, an amount of change calculated by multiplying the current machining condition by a specific coefficient preset for each type of the machining condition, or an amount of change calculated by multiplying the current machining condition by a rate of an amount of increase or decrease from the previous power consumption amount to the current power consumption amount.

9. The power consumption amount adjustment device according to claim 2, wherein
the amount of change is an amount of change calculated depending on an amount of increase or decrease from a sum of energy losses of a motor calculated from the previous power consumption amount to a sum of energy losses of a motor calculated from the current power consumption amount, or an amount of increase or decrease from a sum of energy losses of a drive unit calculated from the previous power consumption amount to a sum of energy losses of a drive unit calculated from the current power consumption amount.

10. The power consumption amount adjustment device according to claim 9, wherein
the amount of change is an amount of change calculated by multiplying the current machining condition by a rate of the amount of increase or decrease of the sum of the energy losses of the motor, or an amount of change calculated by multiplying the current machining condition by a rate of the amount of increase or decrease of the sum of the energy losses of the drive unit.

11. The power consumption amount adjustment device according to claim 1, wherein
the machining condition information generator is a machine learning device that learns the machining condition information, and
the machine learning device includes:
state observation circuitry to observe the previous power consumption amount, the current power consumption amount, and the current machining condition as state variables; and
learning circuitry to learn the machining condition information in accordance with a data set created on a basis of the state variables.

12. The power consumption amount adjustment device according to claim 1, wherein
in a case where an amount of power variation that is a difference between the previous power consumption amount and the current power consumption amount is equal to or less than a first threshold, or a case where an amount of energy loss variation that is a difference between an energy loss calculated from the previous power consumption amount and an energy loss calculated from the current power consumption amount is equal to or less than a second threshold, the machining condition information generator does not change the machining condition information.

13. A numerical control device that adjusts an amount of power consumption of a numerical control machine tool that drives a motor and performs machining in accordance with a machining program, the numerical control device comprising:
a power consumption amount calculation calculator to calculate an amount of power consumption of the numerical control machine tool;
a machining condition information generator to generate, on a basis of a previous power consumption amount that is an amount of power consumption at a time of previous execution of a machining program, a current power consumption amount that is an amount of power consumption at a time of current execution of the machining program, and a current machining condition that is a machining condition at a time of current execution of the machining program and affects the current power consumption amount, machining condition information for determining a next machining condition so that a next power consumption amount that is an amount of power consumption at a time of next execution of the machining program becomes smaller than the current power consumption amount, the next machining condition being a machining condition at a time of next execution of the machining program and affecting the next power consumption amount; and
a machining program executor to execute the machining program repeatedly, and to use the machining condition information determined by the machining condition information generator when executing the machining program.

14. A power consumption amount adjustment method that adjusts an amount of power consumption of a numerical control machine tool that drives a motor and performs machining in accordance with a machining program, the power consumption amount adjustment method comprising:
a machining condition information generation of generating, on a basis of a previous power consumption amount that is an amount of power consumption at a time of previous execution of a machining program, a current power consumption amount that is an amount of power consumption at a time of current execution of the machining program, and a current machining condition that is a machining condition at a time of current execution of the machining program and affects the current power consumption amount, machining condition information for determining a next machining condition so that a next power consumption amount that is an amount of power consumption at a time of next execution of the machining program becomes smaller than the current power consumption amount, the next machining condition being a machining condition at a time of next execution of the machining program and affecting the next power consumption amount.
